(19) United States
(12) Patent Application Publication
(10) Pub. No.: US 2007/0111754 A1
(43) Pub. Date: May 17, 2007

(54) User-wearable data acquisition system including a speaker microphone that is couple to a two-way radio

(76) Inventors: Bill Clifford Marshall, Woodland Hills, UT (US); Christina Mae Marshall, Woodland Hills, UT (US); Daniel J. Patten, Pleasant Grove, UT (US)

Correspondence Address: Angus C. Fox, III, 4093 N. Imperial Way, Provo, UT, 84604-5386, US

(21) Appl. No.: 11/273,951

(22) Filed: Nov. 14, 2005

(51) Int. Cl. H04M 1/00

(52) U.S. Cl. 455/556.1; 348/14.01

(57) ABSTRACT

A data acquisition system including at least a speaker and a microphone coupled to a two-way radio, in addition to audio recording circuitry and multi-use audio memory coupled to the microphone. The system may further include a video camera lens, an image sensor for receiving images through the camera lens, video recording circuitry, and rewriteable digital video memory. Intercoupling of the various devices included in the system may be via either wired communication or wireless radio frequency communication. All components of the system may be contained in a single housing, such as a speaker microphone. Alternatively, the various components may be distributed in several interconnected modules. The system may further include a light source having at least one light-emitting diode. The various components are powered by an electro-chemical power supply, which may be either integral with the two-way radio or separate therefrom.

### BACKGROUND OF THE INVENTION

1. Field of the Invention

The present invention relates in general to user wearable data acquisition systems which include a speaker microphone.

2. History of the Prior Art

Police, fire and other emergency and security personnel often wear portable two-way radios, or transceivers, while on the job so that they can transmit and receive information to and from other radios and/or a communications center. Such radios, which are particularly useful when executing vehicle stops, performing detective work, and assisting during emergencies, are typically worn on a belt or strap. The radios often utilize a handheld combination microphone and speaker, known as a speaker mic, shoulder mic, or remote speaker mic. So that the user's hands may remain free during periods of communication, the speaker mic should be placed sufficiently near the user's head so that the user can both speak into and receive messages from the speaker mic. Most speaker mics on the market today are equipped with a spring-loaded clip which enables the speaker mic to be attached to a user's shirt on the shoulder epaulet, pocket or collar, or other articles of clothing, thus eliminating the need to hold it in the user's hand while being used.

The litigious nature of contemporary American society has created the need for police and other public officials to document their interactions with the public. The documentation must be automatic so that a public official may perform his job without interference from the documentation generation process. In addition, the generated documentation must be sufficiently reliable so as to be legally admissible as evidence.

What is needed is a portable data acquisition system that incorporates a speaker mic and that is fully integrated with a two-way radio. This incorporation of the data acquisition system into units already used by policepersons, firepersons etc eliminates the need to attach yet another device to their already crowded utility belt or clothing as the officer is already wearing the radio and speaker mic. The data acquisition system should be capable of continuously recording any interaction with the public.

### SUMMARY OF THE INVENTION

The present invention fulfills the need for a portable, user-wearable data acquisition system that incorporates a speaker mic and is fully integrated with a two-way radio. As a minimum, the data acquisition system includes a speaker and microphone that are coupled to a two-way radio. In addition, the speaker microphone is coupled to audio recording circuitry and re-useable audio memory. The audio recording circuitry and audio memory are powered by an electro-chemical power supply, which may be either integral with the two-way radio or separate therefrom. In order to eliminate the need for analog-to-digital conversion circuitry, the audio memory may be a multi-level analog storage chip, such as the patented Chipcorder manufactured by Winbond Corporation. However, other types of audio memory, such as digital memory and micro hard disc storage are also contemplated.

The data acquisition system may further include a video camera lens, an image sensor for receiving images through the camera lens, video recording circuitry, and rewriteable digital video memory Non-volatile memory, such as flash memory or micro hard disc storage, is used for the rewriteable digital video memory. It should be understood that for a data acquisition system combining both audio and video recording capabilities, both the re-useable audio memory and the re-writeable video memory may be combined by using, for example, flash memory or micro hard disc storage for both functions. Inter-coupling of the various devices included in the data acquisition system may be via either wired communication or wireless communication. All components of the data acquisition system may be contained in a single housing, such as a speaker microphone. Alternatively, the various components may be distributed in several interconnected modules. For example, if the speaker mic is in the form of a headset, the other components may be contained within a separate single housing or separate multiple housings attachable to the user's clothing.

As an option, the data acquisition system may include a light source having at least one light-emitting diode (LED). The LED may emit light in the visible range, or alternatively, may emit light in the infra-red range. Optionally, both visible and infra-red emitting LEDs may be included in the light source, with each type of emission being individually user selectable. Infrared emission is desirable for certain applications because it provides the capability for photography under conditions perceived by the human eye as darkness. The light source may be mounted on a stalk or arm, which may be adjusted to direct the beam from the light source in a desired direction. The light source is powered by the electro-chemical power supply.

Control of the data acquisition system is provided by a user interface that may be as simple as multiple switches or as complex as a user control interface incorporating a microprocessor or microcontroller, multiple input switches and even an alpha numeric keypad, and/or a video display. Control inputs may be provided by touch-screen capability provided by the video display. For a preferred embodiment of the data acquisition system, a data transfer interface is provided for the transfer of stored data to other computer systems. The interface may incorporate a hard wired port, such as a Uniform Serial Bus (USB) or wireless interconnectivity using, for example, radio frequency signals (RF), infrared signals (IR), or Blue Tooth Signals.

### BRIEF DESCRIPTION OF THE DRAWING

FIG. 1 is a block diagram of the user-wearable data acquisition system;

FIG. 2 is a front elevational view of two-way radio connected to a shoulder speaker/microphone incorporating the entire user-wearable data acquisition system;

FIG. 3 is a rear elevational view of the shoulder speaker/microphone of FIG. 2;

FIG. 4 is a front elevational view of a two-way radio connected to a user-wearable data acquisition system that includes two interconnected modules;

FIG. 5 is a front elevational view of a two-way radio connected to a user-wearable data acquisition system that includes a headset and a single module incorporating system controls, data storage, a video camera module, and two light sources; and

FIG. 6 is a front elevational view of a two-way radio connected to a user-wearable data acquisition system that includes a headset, a first module incorporating at least a push-to-talk switch and earphone volume control, and a second module incorporating a video camera module, data storage, two light sources and a user control interface.

### DETAILED DISCLOSURE OF THE INVENTION

The invention will now be described with reference to the attached drawing figures. It should be understood that the physical appearance of the various components may vary greatly, depending on the design of the various housings, the types of switches, the type of microphone, the type of speaker, the type of camera module and the type of battery used.

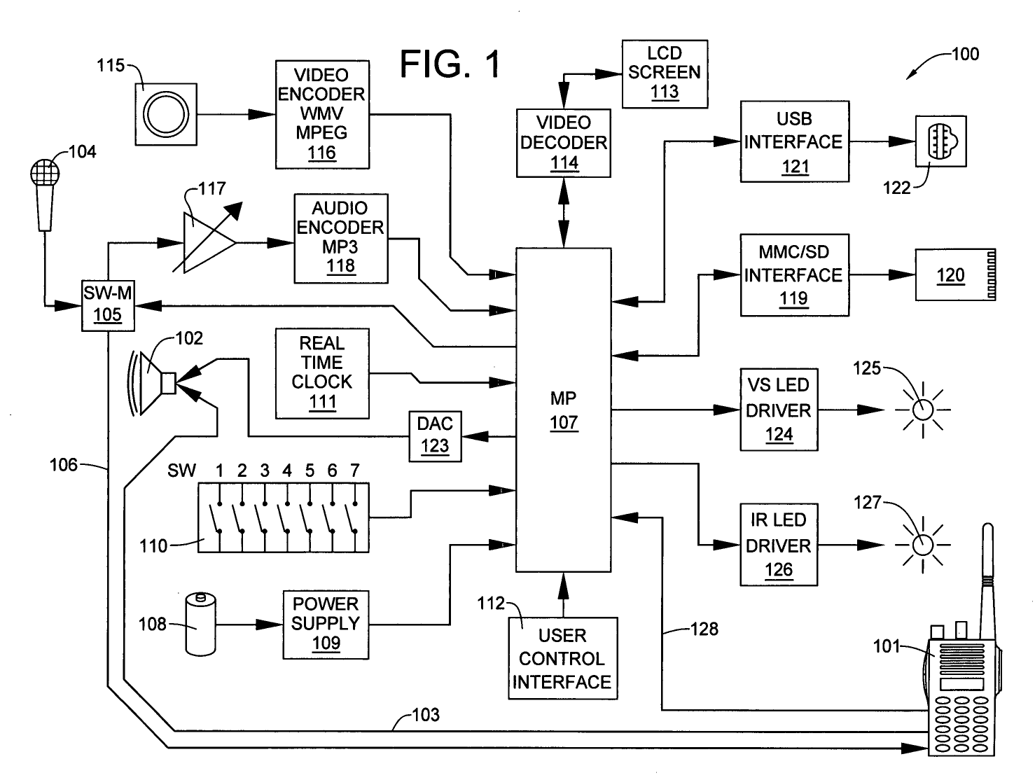

Referring now to FIG. 1, the user-wearable data acquisition system 100 may be coupled to a radio transceiver 101 so that the microphone 111 and the speaker 114 of the system 100 may be used, via multiplexing, in conjunction with the radio 101. A speaker 102 is coupled directly to the radio transceiver 101 via line 103. A microphone 104 is coupled to the radio transceiver 101 via a microphone switch 105 and line 106. Line 103 and line 106 may also represent wireless links between the radio transceiver 101 and the data acquisition system 100. At the heart of the data acquisition system 100 is a microprocessor 107, which is responsible for performing control and data-routing functions. For the purposes of this application, a microprocessor should be considered equivalent to a microcontroller. The microprocessor 107 and other system components are powered by an electro-chemical power source 108 acting through a power supply 109. The electrochemical power source 108 may be one cell, multiple cells, a single battery or multiple batteries. For example, at least one 3-volt rechargeable lithium battery of the CR123 type may be used for this application. In the interest of compactness, the microprocessor 107 preferably has on-board ROM, which stores a limited-use operating system and on-board RAM, into which the operating system is loaded and data is processed. Alternatively, ROM and RAM that are separate from the microprocessor 107 may be provided. A limited-use operating system may be constructed using, for example, a stripped-down version of Linux that has been optimized for this application. A switch module 110, which includes switches SW1, SW2, SW3, SW4, SW5, SW6 . . . SWn provides basic operational signals to the microprocessor 107. Those signals are used to activate or deactivate system functions. For example, one of the switches on module 110 may be used to initiate an upload of stored audio and/or video data to a computer system, to route audio signals via microphone switch SW-M from the microphone 104 either directly to the radio 101, or to an audio encoder 119 through an automatic gain control device 118. A real-time clock 111 provides time and date stamp capability for audio and video recordings which are acquired by the system 100. A user control interface 112, which may include a keyboard or other control elements, provides for user data input to the system (e.g., to set the clock), as well as comprehensive access to system operation and feature selection, and feature options. An LCD screen 113 provides for the viewing of system parameters, as well as for playback of stored video data through video decoder 114. It should be noted that the user control interface 112 and the LCD screen 113 may be combined as a single unit if, for example, the LCD screen 113 is equipped with touch-screen capability.

Still referring to FIG. 1, the data acquisition system 100 also includes a camera module 115 (including a lens and an image sensor) that transmits images to a video encoder 116, which encodes the images in a format such as Windows Media Video (WMV) or Moving Picture Experts Group (MPEG). Analog audio signals are generated by the microphone 104 in response to the receipt of sound waves. When the record function is selected using the switch module 110, the audio signals are first sent to an automatic gain control 117, then to an audio encoder 118, which formats the audio signals in a storable format, such as MP3 or Windows Media Audio (WMA), which are both lossy formats. The microprocessor routes the formatted image or sound data to a Multi Media Card/Secure Digital Interface 119, which writes the formatted data to a digital semiconductor memory card 120. A USB interface 121 and USB connector socket 122 enable stored audio/video data to be uploaded to a computer (not shown). The interface to other computers may also be implemented with wireless interconnectivity using, for example, radio frequency signals (RF), infrared signals (IR), or Blue Tooth Signals. Control over this process may be provided by either the switch module 110 or the user control interface 112. Alternatively, using an audio replay function, stored audio data may routed to the speaker 102 through digital-to-analog (DAC) converter 123. Likewise, using a video replay function, stored video data may be routed to the video display screen 113 through the video decoder 114. In response to a signal provided by the switch module 110 in response to user input, the microprocessor can activate either visible spectrum LED driver 124, which preferably turns on a white light emitting LED 125, or infrared LED driver 126, which turns on an infra-red light emitting LED 127. Control over this process may be provided by either the switch module 122 or the user control interface 121. It will be noted that the radio transceiver 101 is coupled to the microprocessor 107 via line 128. For a configuration where the data acquisition system 100 does not have its own power supply, line 128 provides electrical power from a battery (not shown) located within the radio transceiver housing 101. That battery may supply power to both the radio transceiver 101 and the data acquisition system 100.

In the data acquisition system 100 of FIG. 1, both audio and video recording are implemented in digital formats using a single shared memory 120, although audio and video recording may each have a separate memory. The audio recording circuitry can be considered to comprise the automatic gain control device 117, the audio encoder 118, and the MMC/SD interface 119. Likewise, the video recording circuitry can be considered to comprise the video encoder 116 and the MMC/SD interface 119.

For a data acquisition system which omits video recording capability, the system can be made more compact by implementing audio recording capability using a single chip solution for analog recording and playback. This technology, which was initially developed by Information Storage Devices, Inc. (ISD), of San Jose, Calif., utilizes an array of non-volatile EEPROM or Flash memory cells, each of which can be programmed with a control gate voltage value that corresponds to a frequency value within a range which covers audible sound. The technology has been further developed by Winbond Electonics Corporation, which purchases IDS several years ago. The technology is disclosed in many U.S. patents that were originally assigned to ISD and that have been reassigned to Winbond. Additional patents have recently issued to Winbond covering further developments to the technology. The following U.S. patents are representative of the analog storage and playback technology: U.S. Pat. No. 4,989,179 to Richard T. Simko; U.S. Pat. No. 5,815,435 to Hieu Van Tran; and U.S. Pat. No. 5,959,883 to James Brennan, Jr., et al. The disadvantage of using analog memory for audio recording is that the data files are not easily uploadable to recipient computers.

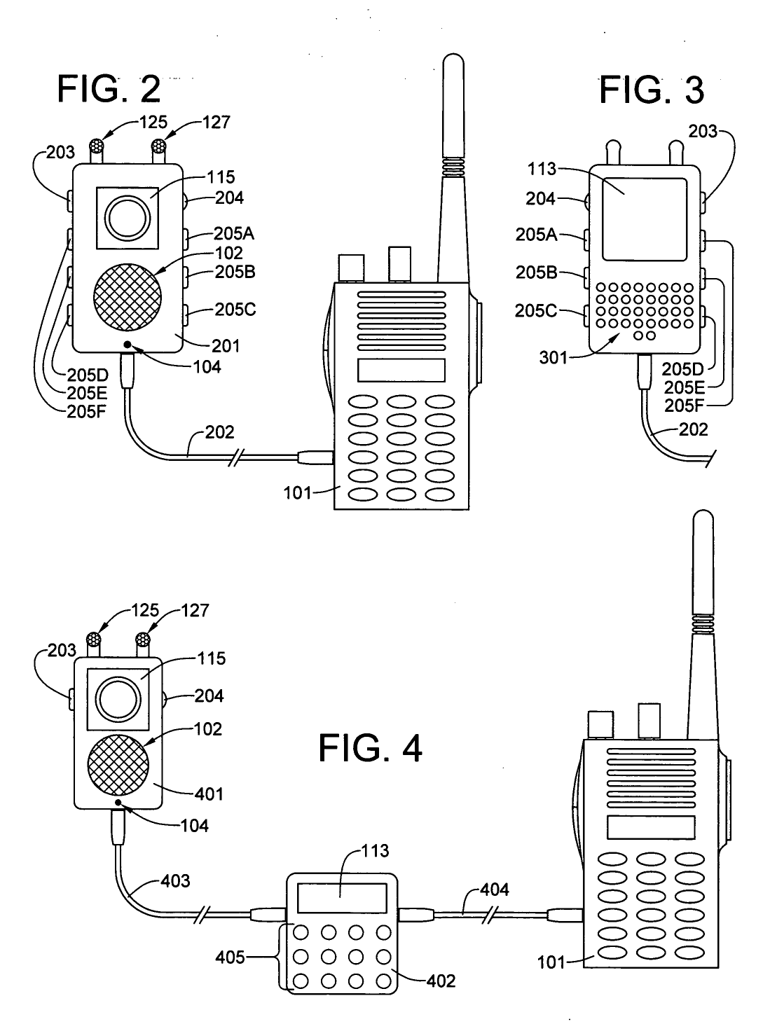

Drawing FIGS. 2 through 7 show various configurations of the combination of a radio transceiver 101 and the data acquisition system 100. Each of the configurations will now be described in detail.

Referring now to FIG. 2, a first system configuration is fully integrated in a single module 201 having an on-board battery 108. A speaker 102 and a microphone 104 may be coupled to a radio transceiver 101 via a cable 202. Clearly, the cable 202 may be eliminated by using a wireless connection between the module 201 and the radio transceiver 101. The module 201 also includes a video camera module 115, a visible spectrum LED light source 125, an infrared LED light source 127, a push-to-talk switch 203, and a speaker volume control 204. Other additional control buttons 205A-204F may be used to access various system functions. The system battery 108, power supply 109, audio recording circuitry (117, 118, and 119), non-volatile audio memory 120, video recording circuitry (116 and 119), non-volatile video memory 120 may be located in either module 201 or in the radio transceiver 101 or distributed between the two. For an alternative configuration, the on-board battery 108 is eliminated and the data acquisition system relies on battery power provided by the radio transceiver 101 through cable 201.

Referring now to FIG. 3, the back side of module 200 incorporates a display screen 113 and a keyboard 301, which may be used for system control and input.

Referring now to FIG. 4, a second system configuration is integrated within first and second modules 401 and 402, respectively, which are coupled together with a first cable 403. Second module 402 is coupled to the radio transceiver 101 via a second cable 404. The first module 401 incorporates a speaker 102, a microphone 104, a video camera module 115, a visible spectrum LED light source 125, an infrared LED light source 127, a push-to-talk switch 202, and a speaker volume control 203. The system battery 108, power supply 109, audio recording circuitry (117, 118, and 119), non-volatile audio memory 120, video recording circuitry (116 and 119), non-volatile video memory 120 are distributed among the first and second modules 401 and 402. Optionally, the system battery 108 may be eliminated by the use of the battery located within the radio transceiver 101. It will be noted that the second module 402 includes control keys, or buttons 405 and a display screen 113 for viewing system parameters, system status, system inputs, and so forth.

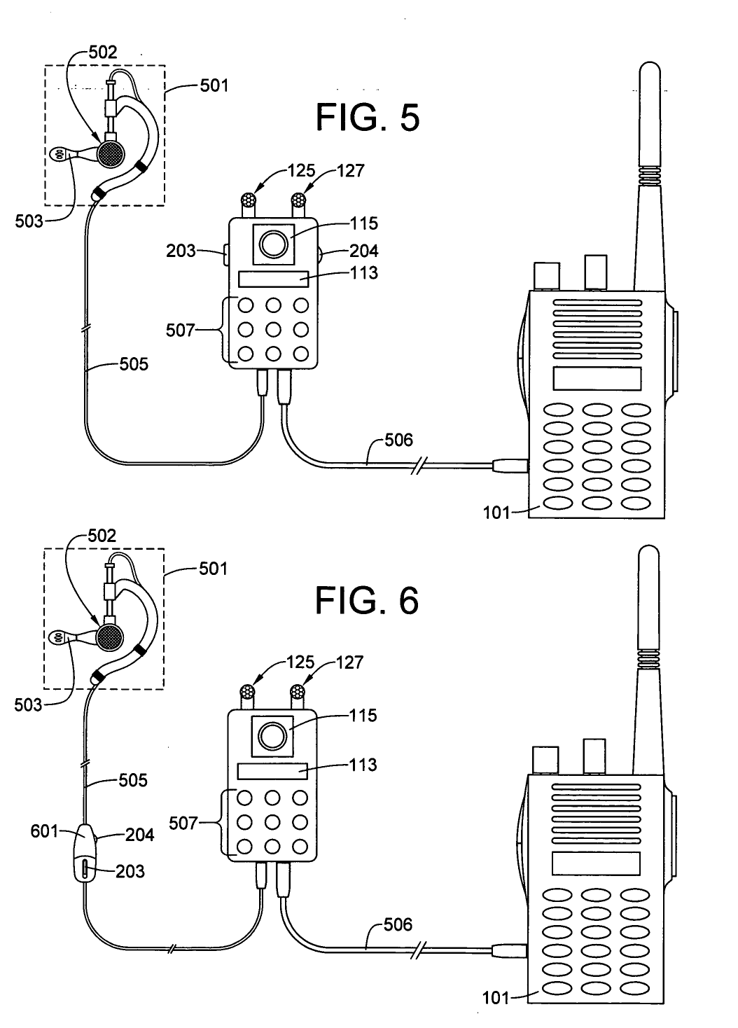

Referring now to FIG. 5, a third system configuration includes a headset 501 that incorporates a earphone 502 and a mini-boom microphone 503. It also includes a control module 504 that incorporates a video camera module 115, a visible spectrum LED light source 125, an infrared LED light source 127, a push-to-talk switch 202, and a speaker volume control 203, as well as the system battery 108, power supply 109, audio recording circuitry (117, 118, and 119), non-volatile audio memory 120, video recording circuitry (116 and 119), and non-volatile video memory 120. Optionally, the system battery 108 may be eliminated by the use of the battery located within the radio transceiver 101. The headset 501 and the control module 504 are coupled together with a first cable 505. The control module 504 is coupled to the radio transceiver 101 via a second cable 506. It will be noted that the control module 504 includes control keys, or buttons 507, and a display screen 113 for viewing system parameters, system status, system inputs, and so forth.

Referring now to FIG. 6, a fourth system configuration is identical to that of FIG. 5, with the exception that a separate push-to-talk switch/volume adjust module 601 is inserted in the first cable 505, thereby eliminating the need for a push-to-talk switch and a volume adjust control on the control module 504.

Still referring to FIG. 6, for a system configuration that includes only a speaker, a microphone, and audio recording capability, the control module 504 may be eliminated and all functions and internal components thereof moved to the radio transceiver 101. For such a configuration, the battery of the radio transceiver 101 would power the data acquisition system.

It should be understood that inter-coupling of the various devices and/or modules included in the data acquisition system may be via either wired communication or wireless communication, as both means of data communication are well known in the art.

Although only several embodiments of the invention has been shown and described, it will be obvious to those having ordinary skill in the art that changes and modifications may be made thereto without departing from the scope and the spirit of the invention as hereinafter claimed.

What is claimed is:

1. In combination with a user-wearable radio transceiver, a user-wearable data acquisition system comprising:
a first module containing a speaker and a microphone, said speaker being coupleable to an output stage of said radio transceiver and said microphone being coupleable to an input stage of said radio transceiver;
an electro-chemical power supply;
audio recording circuitry that is both coupleable to said microphone and powered by said power supply;
non-volatile audio memory coupled to said audio recording circuitry.

2. The combination of claim 1, wherein said non-volatile audio memory is selected from the group consisting of digital memory and multi-level-storage analog memory.

3. The combination of claim 1, wherein said electro-chemical power supply, said audio recording circuitry, and said non-volatile audio memory are located within at least one of the modules in the group consisting of a housing of said radio transceiver, said first module, a second module, and a third module, each of said three modules being physically separate from said radio transceiver.

4. The combination of claim 3, wherein any intercoupling between the various modules and said radio transceiver is accomplished by means selected from the group consisting of wired communication and wireless communication.

5. The combination of claim 3, which further comprises at least one LED light source switchably coupled to said electro-chemical power supply, said at least one LED light source being attached to one of the modules in the group consisting of said first, second and third modules.

6. The combination of claim 5, which further comprises a first LED visible light source and a second LED infrared light source.

7. The combination of claim 1, wherein said electro-chemical power supply is located within said radio transceiver and also powers the latter.

8. The combination of claim 1, which further comprises:
an exposed, forward-facing video camera lens;
a video encoder;
an image sensor for receiving images through said camera lens, said image sensor coupled to said video encoder;
video recording circuitry coupled to said video encoder;
non-volatile video memory coupled to said video recording circuitry; and
a microprocessor for implementing system control and signal routing functions.

9. The combination of claim 7, wherein said electro-chemical power supply, said audio recording circuitry, said non-volatile audio memory, said forward-facing video camera lens, said video encoder, said image sensor, said video recording circuitry, said non-volatile video memory, and said microprocessor are located within at least one of the group of modules consisting of a housing of said radio transceiver, said first module, a second module, and a third module, each of said three modules being physically separate from said radio transceiver.

10. The combination of claim 8, which further comprises at least one LED light source switchably coupled to said electro-chemical power supply, said at least one LED light source being attached to one of the modules in the group consisting of said first, second and third modules.

11. The combination of claim 10, which further comprises a first LED visible light source and a second LED infrared light source.

12. The combination of claim 7, wherein said non-volatile audio memory and said non-volatile video memory are digital semiconductor memory and unitary.

13. The combination of claim 7, wherein said electro-chemical power supply is located within said radio transceiver and also powers the latter.

14. In combination with a user-wearable radio transceiver, a user-wearable data acquisition system comprising:
an electro-chemical power supply;
audio recording circuitry powered by said power supply;
non-volatile audio memory coupled to said audio recording circuitry;
a microphone coupleable to both an input stage of said radio transceiver and to said audio recording circuitry; and
a speaker coupled to an output stage of said radio transceiver.

15. The combination of claim 14, which further comprises at least one LED light source switchably coupled to said electro-chemical power supply.

16. The combination of claim 15, which further comprises a first LED visible light source and a second LED infrared light source.

17. The combination of claim 14, wherein said electro-chemical power supply, said audio recording circuitry, said non-volatile audio memory, said microphone, and said speaker are mounted in a single housing that is coupleable to said radio transceiver.

18. The combination of claim 14, wherein said microphone and said speaker are incorporated in a single headset module, and said electro-chemical power supply, said audio recording circuitry, and said non-volatile audio memory are mounted in a separate housing that is coupleable to both said headset and said radio transceiver.

19. The combination of claim 14, wherein said electro-chemical power supply is located within said radio transceiver and also powers the latter.

20. The combination of claim 14, wherein said non-volatile audio memory is selected from the group consisting of digital memory and multi-level-storage analog memory.

21. The combination of claim 14, wherein said microphone and said speaker are located in a first module, and said electro-chemical power supply, said audio recording circuitry, and said non-volatile audio memory are located within at least one of the group of modules consisting of a housing of said radio transceiver, said first module, a second module, and a third module, each of said three modules being physically separate from said radio transceiver.

22. The combination of claim 21, wherein any intercoupling between the various modules and said radio transceiver is accomplished by means selected from the group consisting of wired communication and wireless communication.

23. The combination of claim 14, which further comprises:
an exposed, forward-facing video camera lens;
a video encoder;
an image sensor for receiving images through said camera lens, said image sensor coupled to said video encoder;
video recording circuitry coupled to said video encoder;
non-volatile video memory coupled to said video recording circuitry; and
a microprocessor for implementing system control and signal routing functions.

24. The combination of claim 23, which further comprises at least one LED light source switchably coupled to said electro-chemical power supply.

25. The combination of claim 24, which further comprises a first LED visible light source and a second LED infrared light source.

26. The combination of claim 23, wherein said electro-chemical power supply, said audio recording circuitry, said non-volatile audio memory, said microphone, said speaker, said forward-facing video camera lens, said image sensor, said video encoder, said video recording circuitry, said non-volatile video memory, and said microprocessor are mounted in a single housing.

27. The combination of claim 23, wherein said microphone and said speaker are incorporated in a single headset module, and said electro-chemical power supply, said audio recording circuitry, said non-volatile audio memory, said forward-facing video camera lens, said image sensor, said video encoder, said video recording circuitry, said non-volatile video memory, and said microprocessor are mounted in a separate housing that is coupleable to both said headset and said radio transceiver.

28. The combination of claim 23, wherein said electro-chemical power supply is located within said radio transceiver and also powers the latter.

29. The combination of claim 23, wherein said non-volatile audio memory and said non-volatile video memory are unitary and digital.

30. The combination of claim 23, wherein said microphone and said speaker are located in a first module, and said electro-chemical power supply, said audio recording circuitry, said non-volatile audio memory, said forward-facing video camera lens, said video encoder, said image sensor, said video recording circuitry, said non-volatile video memory, and said microprocessor are located within at least one of the group of modules consisting of a housing of said radio transceiver, said first module, a second module, and a third module, each of said three modules being physically separate from said radio transceiver.
